(19) United States
(12) Patent Application Publication
(10) Pub. No.: US 2015/0051728 A1
(43) Pub. Date: Feb. 19, 2015

(54) DETECTING METHOD OF ABNORMALITY OF MACHINE TOOL OPERATION

(71) Applicants: KOREA TOOL MONITORING CO., LTD., Siheung (KR); DASAN TOOL CO., LTD., Wanju-gun (KR)

(72) Inventors: Byung-Hak KIM, Jeonju (KR); Jong-Kook KIM, Incheon (KR)

(73) Assignees: KOREA TOOL MONITORING CO., LTD., Siheung (KR); DASAN TOOL CO., LTD., Wanju-gun (KR)

(21) Appl. No.: 14/104,825

(22) Filed: Dec. 12, 2013

(30) Foreign Application Priority Data
Aug. 14, 2013 (KR) 10-2013-0096931

(51) Int. Cl. G05B 19/4065

(52) U.S. Cl. CPC G05B 19/4065
USPC 700/175

(57) ABSTRACT

Provided is a detecting method of abnormality of a machine tool operation, and the detecting method includes a preparing step S100; a reference waveform obtaining step S200 of measuring a drive voltage and a drive current, while machining the material in a normal state of the machine tool, and obtaining a reference waveform; a monitoring section setting step S300 of setting a monitoring section and thus automatically calculating a maximum load value and a minimum load value; a permissible limit setting step S400 of setting maximum and minimum permissible limits; and a monitoring step S500 of obtaining a machining load generated and determining whether a difference between maximum and minimum load values of the machining load is out of the maximum or minimum permissive limit and then outputting normality or abnormality thereof.

### CROSS-REFERENCE(S) TO RELATED APPLICATIONS

The present invention claims priority of Korean Patent Application No. 10-2013-0096931, filed on Aug. 14, 2013, which is incorporated herein by reference.

### BACKGROUND OF THE INVENTION

1. Field of the Invention

The present invention relates to a detecting method of abnormality of a machine tool operation, and more particularly to a detecting method of abnormality of a machine tool operation, which can efficiently detect the wear state of a tool and the abnormal state between a tool and a material occurred upon the operation of a machine tool having a numeric control function.

2. Description of Related Art

Recently, with the development of electronic technology, various machine tools having high accuracy and a numerical control function have been developed and used, and when machining a material using the machine tools, the degree of machining accuracy is typically changed depending on the wear state of a tool, the contact state between a tool and a material, the installation state of a tool in the machine tool or the like. Herein, in order to check the wear state of the tool, the contact state between the tool and the material or the like, it is necessary for an operator to visually confirm the machined state of a work or the wear state of the tool. Further, in case of visually confirming the machined state of the work or the wear state of the tool, the results thereof may be changed depending on skill in individual operator, and the installation state of the tool may be changed depending on skill in individual operator. Therefore, the machining quality of the work and the life span of the tool may be also changed depending on the operators.

In order to solve the above-mentioned problems, there were proposed several methods of automatically detecting and informing the abnormal state of a tool to an operator, which may occur upon the machining operation of a material, and thereby increasing the operation efficiency. One of the methods is a detecting method of abnormality of a tool in a machine tool disclosed in Japanese Patent Laid-Open No. Pyung 9-295250.

In the detecting method, when a material is machined by using a tool with a slow-away chip, a picture of the chip of the tool is taken by imaging means such as a camera, and the brightness distribution of the picture is calculated and then compared with that of other picture, thereby detecting the abnormal state of the tool. Therefore, even when a cutting blade of the chip is blackened or foreign substances are attached thereon, it is possible to certainly detect abnormality of the chip.

However, the above-mentioned detecting method can be applied only to a tool with the chip but cannot be applied to other tools without the chip. Further, it is not possible to detect other abnormal state, e.g., in case that the tool is erroneously installed on the machine tool.

In addition, Japanese Patent Laid-Open No. Sho 61-111877 discloses a “blade loss detector” which detects vibration generated when a blade is lost upon a machining operation. And Japanese Patent Laid-Open No. Pyung 6-39685 discloses an apparatus for detecting tool damage of a machine tool, in which the wear and damage of a blade is detected by using an optical sensor or a TV camera. However, these methods also have a problem in that it is not possible to detect other abnormal state, e.g., in case that the tool is erroneously installed.

In order to solve the above problem in the conventional detecting methods, the inventors proposed a defect detecting method upon handling a machine tool which was granted (Korean Patent No. 952619). In this method, as shown in FIG. 1, there are three limit lines such as an upper limit line KH110, a lower limit line and an essential passage line KH120 which are previously set with respect to a power value generated when machining a material using a machine tool. The power value is continuously detected, and then when the detected power value (actual machining waveform) is out of the range of limit lines or does not pass the essential passage line, the operation of the machine tool is stopped, or the fact is informed to an operator by using alarm means or the like, and thus it is possible to previously prevent deterioration of machining quality due to wear of a tool or chucking miss of the material.

However, in the above-mentioned detecting method (tool monitoring system), when abnormality of a power supply system or shaking of a tool is occurred by external vibration or intermittent instability in power supply, a load (power) value of a motor is suddenly reduced or increased, as shown in FIG. 2. In this case, an actual machining waveform 2 formed based on the detected load value of the motor cannot pass the essential passage line 3 set with respect to a reference waveform 1 or get out of the range of limit lines. As a result thereof, the alarm is erroneously operated, and thus the operator operates the machine tool while turning off the tool monitoring system, thereby deteriorating usefulness and reliability of the tool monitoring system.

### SUMMARY OF THE INVENTION

An embodiment of the present invention is directed to providing a detecting method of abnormality of a machine tool operation, in which alarm is not erroneously operated and also it is possible to precisely detect the abnormality of the machine tool operation, even though the actual machining waveform 2 cannot pass the essential passage line and/or get out of the range of limit lines due to the external vibration or the intermittent instability in power supply.

To achieve the object of the present invention, the present invention provides a detecting method of abnormality of a machine tool operation, which detects chucking miss of a material, wear and damage of a tool or the like, including a preparing step of setting a kind of tool and a machining process at a host computer in a state that a current sensor and a voltage sensor are installed at a power line of a motor drive unit of the machine tool and connected to a sensor processor, and the sensor processor is connected to a monitoring controller, and the monitoring controller is connected to the host computer and a machine tool controller; a reference waveform obtaining step of measuring a drive voltage and a drive current using the current sensor and the voltage sensor, while machining the material in a normal state of the machine tool, and obtaining a reference waveform which functions as a standard for determining abnormality of the tool; a monitoring section setting step of setting a monitoring section with respect to the reference waveform obtained in the reference waveform obtaining step and thus automatically calculating a maximum load value and a minimum load value; a permissible limit setting step of setting maximum and minimum permissible limits in order to set an alarm operation section based on the maximum and minimum load values calculated in the monitoring section setting step; and a monitoring step of continuously obtaining a machining load generated when actually machining the material and determining whether a difference between maximum and minimum load values of the machining load obtained in the monitoring section is out of the maximum or minimum permissive limit and then outputting normality or abnormality thereof.

Preferably, the detecting method further includes a stop operation setting step of setting whether to stop the machine tool when the machining load exceeds the permissible limit between the permissible limit setting step and the monitoring step.

Preferably, in the stop operation setting step, it is set that the machine tool is stopped immediately, before or after a machining operation.

Preferably, the detecting method further includes an alarm skip setting step of allowing the operation of alarm to be skipped for preset times between the permissible limit setting step and the monitoring step.

Preferably, the monitoring step comprises a monitoring data storing step of storing monitoring data by tools, operations, dates and hours when operating the machine tool.

### BRIEF DESCRIPTION OF THE DRAWINGS

FIG. 1 is a graph showing an example in which three limit lines of an upper limit line, a lower limit line and a essential passage line are set with respect to a power value in a conventional tool monitoring system.

FIG. 2 is a graph showing an example in which a phase difference is occurred in the conventional tool monitoring system.

FIG. 3 is a flow chart showing a detecting method of abnormality of a machine tool operation in accordance with the present invention.

FIGS. 4 and 5 are block diagrams showing an example of the detecting method of abnormality of the machine tool operation in accordance with the present invention.

FIG. 6 is a block diagram showing an example of a monitoring program used in the detecting method of abnormality of the machine tool operation in accordance with the present invention.

FIG. 7 is a graph showing an example of a reference waveform in the detecting method of abnormality of the machine tool operation in accordance with the present invention.

FIG. 8 is a graph showing an example in which a monitoring section is set in the reference waveform of FIG. 7 and then minimum and maximum load values are calculated.

FIG. 9 is a graph showing an example in a maximum permissible limit is set on the basis of the maximum load value of FIG. 8.

FIG. 10 is a graph showing an example in a minimum permissible limit is set on the basis of the minimum load value of FIG. 8.

FIG. 11 is a graph showing an example of an reference waveform and an actual machining waveform

FIGS. 12a and 12b are graphs showing examples in which a maximum load value of an actual machining load is corresponding to an alarm operation section in the detecting method of abnormality of the machine tool operation in accordance with the present invention.

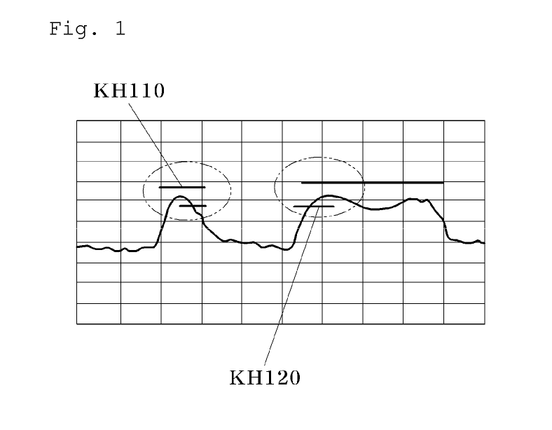

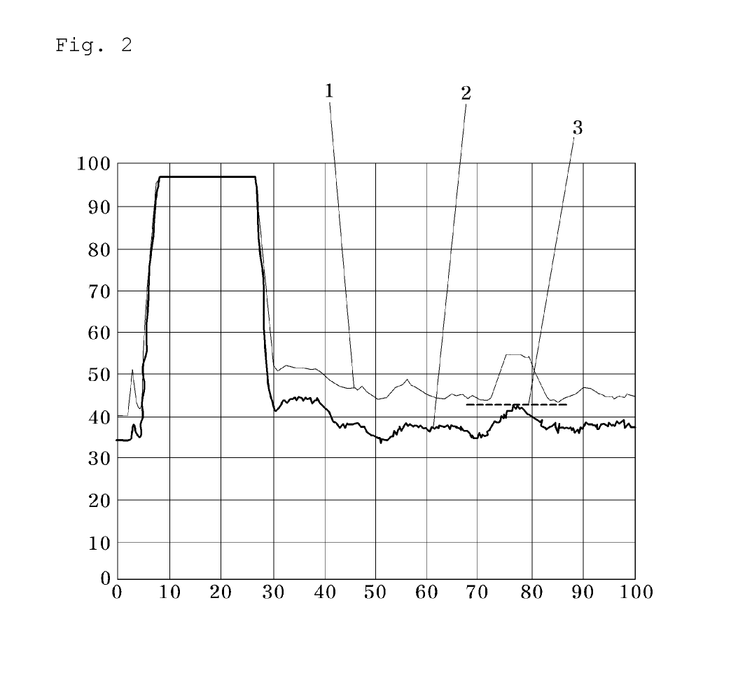

### DETAILED DESCRIPTION OF MAIN ELEMENTS

| | |
|---|---|
| 1: reference waveform | 2: machining waveform |
| 3: essential passage line | 10: sensor processor |
| 20: motor drive unit | |
| 21, 22, 23: servo axis terminal | |
| 24: current sensor | 25: voltage sensor |
| 30: monitoring controller | 40: host computer |
| 50: machine tool controller | C: communication cable |

### Description of Specific Embodiments

The advantages, features and aspects of the invention will become apparent from the following description of the embodiments with reference to the accompanying drawings, which is set forth hereinafter.

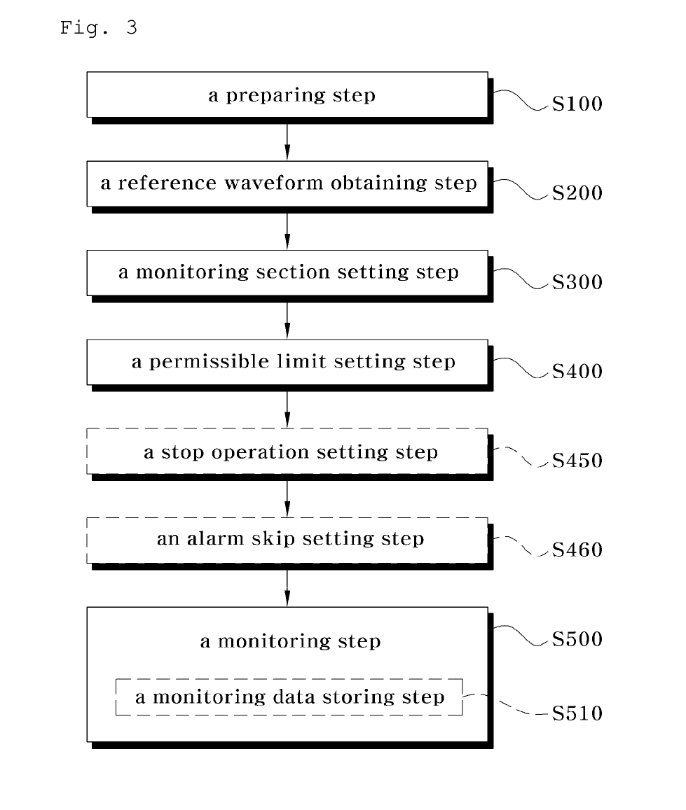

The present invention is to provide a detecting method of abnormality of a machine tool operation, which can precisely detect the abnormality of the machine tool operation, such as the chucking miss of a material, and the wear and damage state of a tool. To this end, as shown in FIG. 3, the present invention includes a preparing step S100, a reference waveform obtaining step S200, a monitoring section setting step S300, a permissible limit setting step S400 and a monitoring step S500. Hereinafter, each step will be described fully.

(1) Preparing Step S100

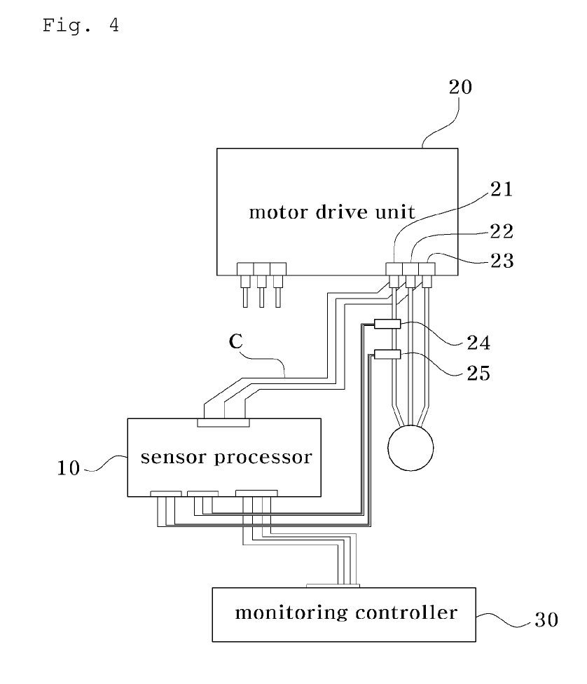

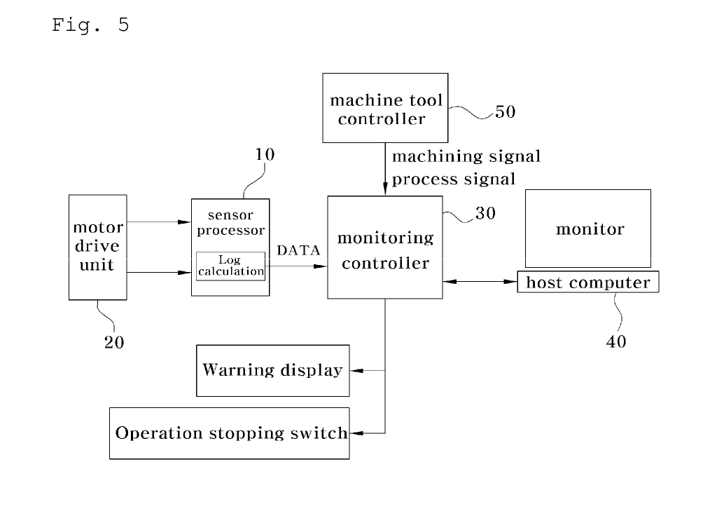

In the preparing step S100, a device for detecting abnormality of a machine tool is provided at the machine tool in order to detect omission of processes due to chucking miss of a material, wear and damage of a tool and error in a monitoring program, and a monitoring environment is set. To this end, as shown in FIGS. 4 and 5, a current sensor 24 and a voltage sensor 25 are provided at a three-phase power line 21, 22, 23 connected to a motor drive unit 20 of a machine tool, and each output terminal of the current sensor 24 and the voltage sensor 25 is connected with a sensor processor 10. The sensor processor 10 is connected again with a monitoring controller 30 through a communication cable C.

The monitoring controller 30 is connected through the communication cable C with a machine tool controller 50 and a host computer 40, which are provided at the machine tool, in order to receive a machining signal, a tool identification number, a product identification number, a process signal and a control instruction from the machine tool controller 50 and the host computer 40 and then control a warning light display device to be described later.

Further, the warning light display device is connected to the monitoring controller 30, and thus if it is diagnosed by the monitoring program that the abnormal state of the machine tool is occurred, the fact is informed to an operator. And an operation stopping switch is also connected to the monitoring controller 30 in order to rapidly stop the operation of the machine tool.

The host computer 40 which is connected to the monitoring controller 30 and in which a monitoring program is installed is provided with an input device such as a keyboard for inputting or selecting the control instruction or necessary information, and a monitor which outputs input information or monitored results. Therefore, the host computer 40 executes the monitoring program based on the control instruction input or selected by the operator and controls the whole monitoring process.

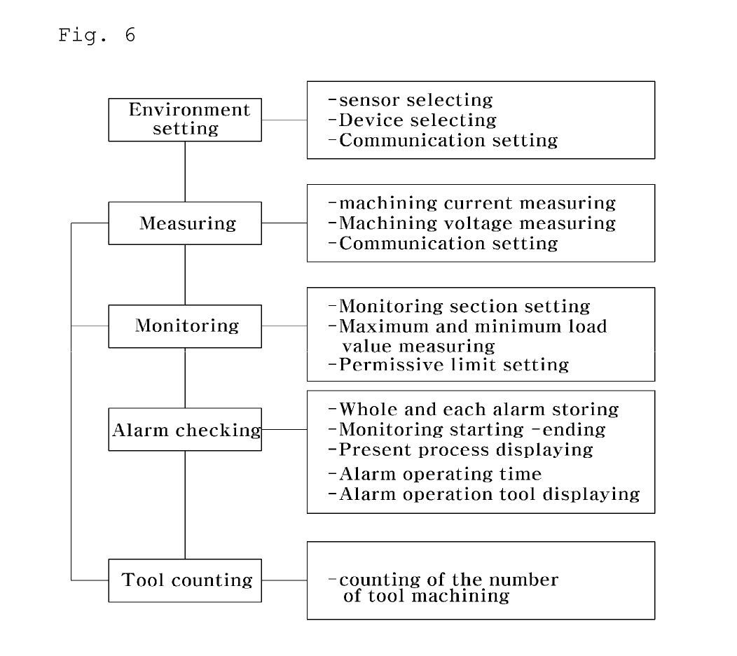

As shown in FIG. 6, the monitoring program installed in the host computer 40 includes program modules for environment setting, measuring, process setting, monitoring, alarm checking, tool counting or the like. Thus, the monitoring program executes a proper program module so that the inputting/outputting of information, the measuring or the monitoring or the like can be performed.

After the sensors, the sensor processor 10, the monitoring controller 30, the machine tool controller 50 and the host computer 40 are connected with each other in the preparing step S100, the operator sets the environment by selecting a machine tool identification number of the machine tool, a kind of the tool or the like through the input device provided at the host computer 40, and then the reference waveform obtaining step S200 is performed.

(2) Reference Waveform Obtaining Step S200

In the reference waveform obtaining step S200, after the connection between the machine tool and the monitoring controller and between the monitoring controller and the host computer, the input of the necessary information and the like are completed in the preparing step S100, a drive voltage and a drive current which is needed to machine the material are measured by the current sensor and the voltage sensor while the machine tool machines a material in the normal state. Then, a reference waveform functioning as a reference that determines whether the tool is abnormal using the measured values is obtained and set.

According to present invention, in order to obtain the reference waveform, a product is experimentally machined in a normal state of the machine tool, the tool and the material. Herein, while as least three or more materials are machined, the drive voltage and the device current are obtained using the current sensor and the voltage sensor. Then, the operator directly makes a visual inspection of the machined produces based on a machining tolerance and thus determines whether the machining operation is performed in the normal state. As a result thereof, if it is determined that the machining operation is performed normally, the drive voltage and the drive current are stored in a sensor processor, and if it is determined that the products are defective, the tool has to be reinstalled and new materials are again chucked and aligned and then the experimental machining operation is performed again.

If the experimental machining operation with respect to at least three products is finished in the normal state, the drive voltage and the drive current stored in the sensor processor are multiplied by each other in order to obtain power values through the time. And log treatment on an average value of the obtained power values is performed and then delivered to the monitoring controller. In such process, reference waveforms through the time are stored in the monitoring controller.

If the reference waveforms are obtained through the above-mentioned processes, the monitoring controller receives a tool identification number, a product identification number from the machine tool controller through the communication cable and delivers to the host computer the reference waveforms according to the information and time. Therefore, each reference waveform according to the tool identification number and the product identification number is stored in the host computer.

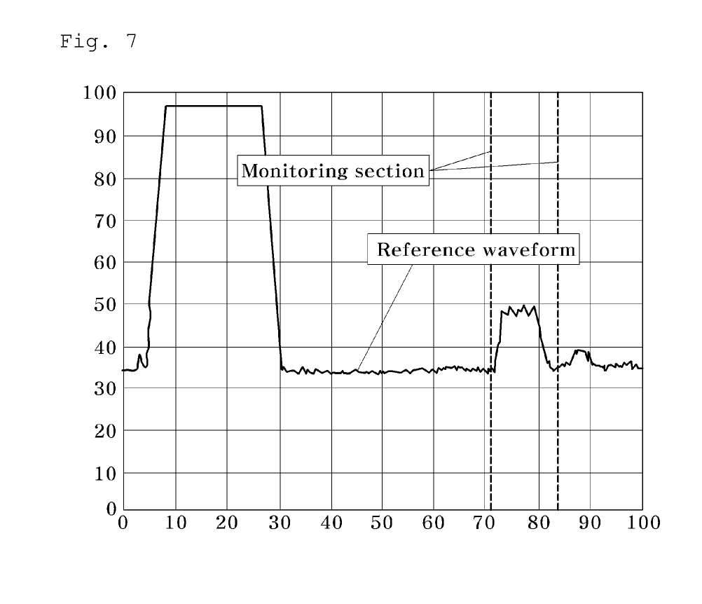

Unlike the reference waveforms delivered from the monitoring controller 40, the reference waveforms in the host computer 40 are stored in the form of a percentage at both horizontal and vertical axes, as shown in FIG. 7. In such conversion, when the power value is zero, it is set to 0% with respect to the vertical axis, and when the power value is maximum, it is set to 100%. And a point of time when the measuring is started to set the reference waveform is set to 0% with respect to the horizontal axis, and a point of time when the measuring is finished is set to 100%.

(3) Monitoring Section Setting Step S300

In the monitoring section setting step S300, after the reference waveforms which are expressed in the form of the percentage by the reference waveform obtaining step S200 are obtained, the operator sets a monitoring section to be monitored using the obtained reference waveforms.

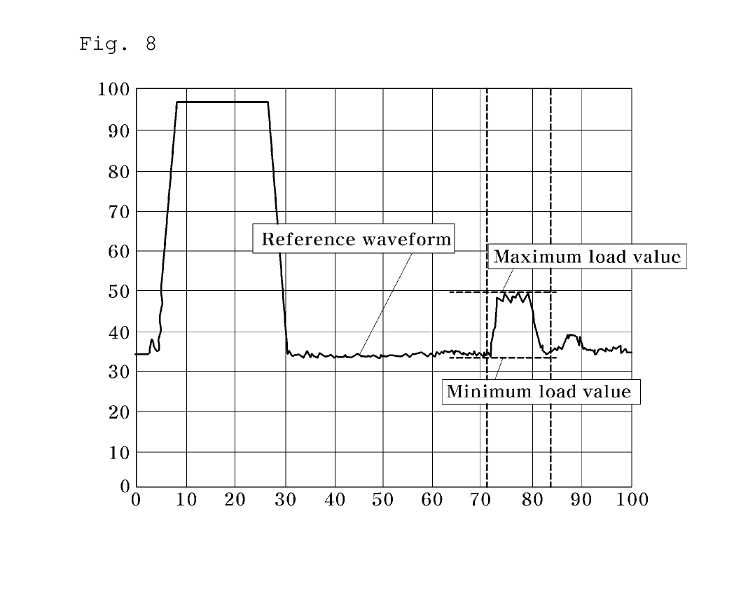

If the reference waveforms expressed in the form of the percentage are obtained in the reference waveform obtaining step S200, the reference waveforms are output through a monitor of the host computer, and at the same time, a setting screen for setting a monitoring section is displayed. And if the operator inputs a monitoring sector to be monitored, which is converted into minimum and maximum percentage values, using the reference waveforms, the monitoring section is displayed on the monitor by the host computer 40, as shown in FIG. 8, and as the same time, maximum and minimum load values in the monitoring section are automatically calculated and then indicated in the form of a limit line.

(4) Permissible Limit Setting Step S400

In this step, a permissible limit value functioning as a standard for determining the abnormal state, e.g., wear or damage of the tool is set.

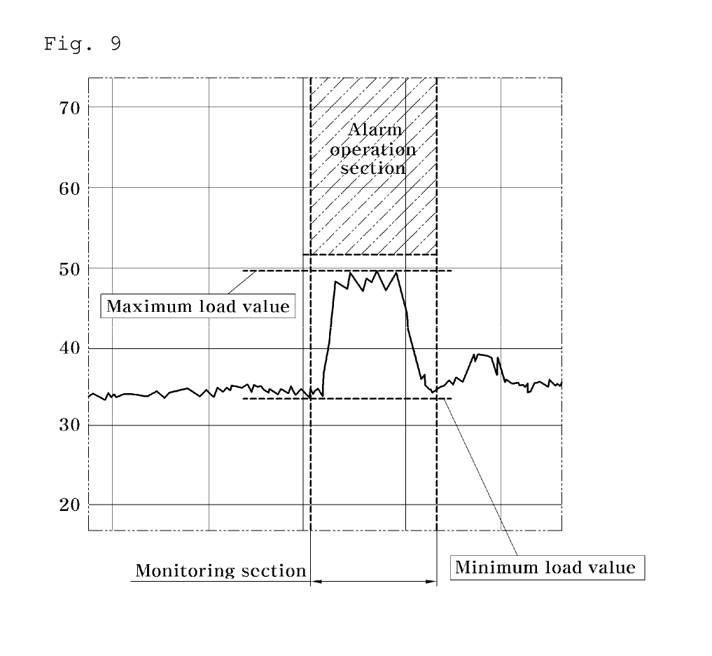

If the maximum and minimum load values are calculated in the monitoring section setting step S300, the operator sets maximum and minimum load values (permissible limit) permissible upon the machining operation. Herein, as shown in FIG. 9, if the maximum permissible limit value (%) is input by the operator, the monitoring program sets an alarm operation section by adding the input maximum permissible limit value (%) to the previously detected minimum load value (%). In case that the maximum load value measured in the monitoring section is included in the alarm operation section, the alarm or warning light is operated. If the alarm is operated by that the measured maximum load value exceeds the set maximum permissible limit, this is typically caused by the wear of the tool. Herein, the maximum permissible limit value is generally larger than a value obtained by taking the minimum load value from the maximum load value.

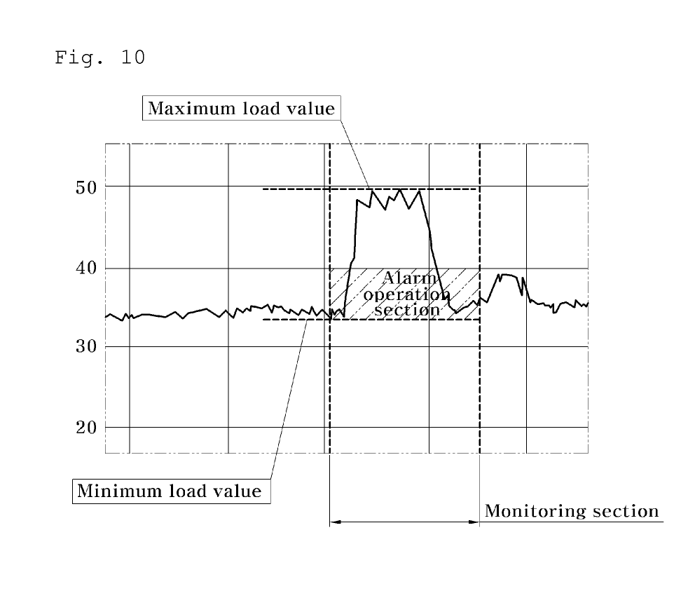

And as shown in FIG. 10, if the operator inputs the minimum permissible limit value (%), the monitoring program also sets an alarm operation section by adding the set minimum permissible limit value (%) to the calculated minimum load value (%). In case that the maximum load value measured in the monitoring section is included in the alarm operation section, the alarm or warning light is operated. If the alarm is operated by that the measured maximum load value is less than the set minimum permissible limit value, this is typically caused by the damage of the tool. Herein, the maximum permissible limit value is generally less than a value obtained by taking the minimum load value from the maximum load value.

In case that the alarm is operated during the monitoring process due to the wear or damage of the tool, it is necessary to previously set whether the operation of the machine tool is stopped immediately or stopped after the machining operation is finished. To this end, the present invention further includes a stop operation setting step S450 of selecting whether to stop the machine tool immediately, before or after the machining operation. Therefore, the operator can set whether to continuously operate the machine tool when the alarm is operated.

In addition, the present invention may further include an alarm skip setting step S460 of allowing the operator to operate the machine tool in a state that the alarm is not operated in any events. To this end, the monitoring program has a function of setting the allowable alarm skipping number, and thus if the operator inputs the allowable skipping number, it is possible to perform the machining operation in the state that the alarm is not operated within the range of the allowable skipping number, even though the maximum load value is included in the alarm operation section. If the allowable skipping number is exceeded, it is not possible to skip the alarm operation. Therefore, the operator stops the machining operation, visually checks the state of the tool and material based on a machining tolerance and then restarts the machining operation. This function is particularly useful in a simple operation in which the monitoring process is not needed.

If the permissible limit setting step S400, the stop operation setting step S450 and/or the alarm skip setting step S460 are completed, the operator selects one of “test” and “monitoring” categories. Herein, if the “test” category is selected, the machine tool is operated with preset options, and it is determined whether the present options are abnormal. If necessary, the preset options may be reset.

And if the “monitoring” category is selected, the monitoring step S500 which will be described below is performed.

(5) Monitoring Step S500

In this step, if the operator selects the “monitoring” category in order to monitor the chucking miss of the material and the abnormal state of the tool when actually machining the material, the machining load generated when machining the material is continuously, and a difference between the maximum load value and the minimum load value of the machining load obtained in the monitoring section designated by the operator is calculated, and it is determined whether the calculated difference is out of the maximum or minimum permissible limit set by the permissible limit setting step S400, and then a result thereof will be output.

Herein, the monitoring program measures the machining load applied when machining the material and displays it in the form of a graph on the monitor. The machining load graph (machining waveform) displayed on the monitor generally has the same shape as the reference waveform. Therefore, in case that the tool is damaged or worn in the set monitoring section, it is out of the permissible limit, and as a result thereof, the warning light is turned on.

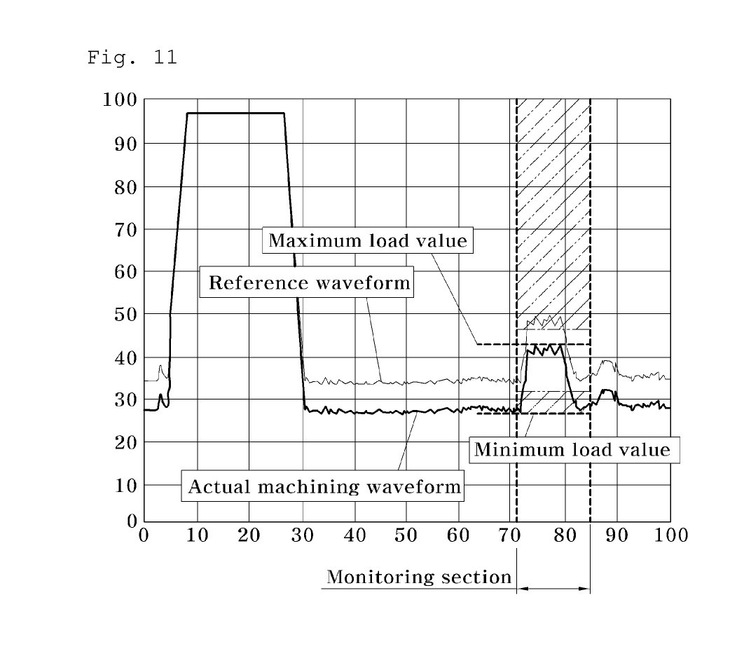

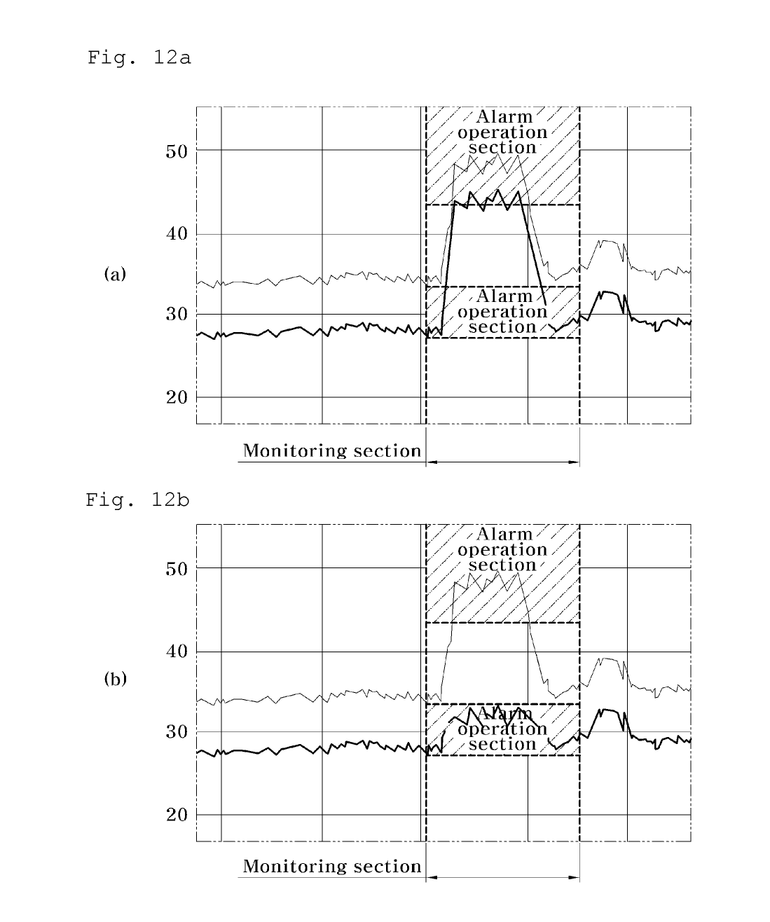

Meanwhile, in case that abnormality of a power supply system is occurred by the external vibration or the intermittent instability in power supply, the machining waveform has a smaller value by a desired interval than the reference waveform, as shown in FIG. 11. In this case, the monitoring program calculates the minimum and maximum load values generated when actually machining the material in the monitoring section, and if the difference therebetween is out of one of the permissible values set in the permissible value setting step S400 and included in the alarm operation section, as shown in FIGS. 12a and 12b, the alarm is operated, and as the same time, the operation of the machine tool is stopped or continued according the stopping operation set by the operator. And if the difference therebetween is not out of one of the permissible values, the machine tool is continuously operated.

Therefore, according to the present invention, even though the abnormality of the power supply system is occurred and the machining waveform is not coincided with the reference waveform, the normal, damage or wear state of the tool is determined on the basis of only a height difference of the machining load in the machining waveform, i.e., the difference between the maximum load value and the minimum load value, and there is no problem in that the alarm is operated in the normal state. Therefore, the monitoring process is precisely performed and thus the reliability of the monitoring process is improved.

Meanwhile, it is preferable that data obtained in the monitoring step S500 is stored by tools, operation, dates and hours and then used later as back data. To this end, the monitoring step S500 includes a monitoring data storing step S510.

If the monitoring data is stored, as described above, it is possible to check monitoring graphs accumulated by tools for every machining process, and it is also possible to anticipate the life span of each tool using the graphs and then apply it to the operation of the machine tool.

Preferably, the operation history of the alarm may be stored together and then used in estimating and analyzing the cause of defects.

According to the present invention, it is possible to precisely detect the wear and damage of the tool and/or the instable chucking of the material while the machine tool is operated.

Further, even though the power supply is in the abnormal state due to the external vibration or the intermittent instability in power supply, it is possible to prevent the operation of alarm, while the detected load value is within a permissible range, thereby increasing the usefulness and reliability of the tool monitoring system.

While the present invention has been described with respect to the specific embodiments, it will be apparent to those skilled in the art that various changes and modifications may be made without departing from the spirit and scope of the invention as defined in the following claims.

1. A detecting method of abnormality of a machine tool operation, which detects chucking miss of a material, wear and damage of a tool or the like, comprising:
a preparing step S100 of setting a kind of tool and a machining process at a host computer in a state that a current sensor and a voltage sensor are installed at a power line of a motor drive unit of the machine tool and connected to a sensor processor, and the sensor processor is connected to a monitoring controller, and the monitoring controller is connected to the host computer and a machine tool controller;
a reference waveform obtaining step S200 of measuring a drive voltage and a drive current using the current sensor and the voltage sensor, while machining the material in a normal state of the machine tool, and obtaining a reference waveform which functions as a standard for determining abnormality of the tool;
a monitoring section setting step S300 of setting a monitoring section with respect to the reference waveform obtained in the reference waveform obtaining step S200 and thus automatically calculating a maximum load value and a minimum load value;
a permissible limit setting step S400 of setting maximum and minimum permissible limits in order to set an alarm operation section based on the maximum and minimum load values calculated in the monitoring section setting step S300; and
a monitoring step S500 of continuously obtaining a machining load generated when actually machining the material and determining whether a difference between maximum and minimum load values of the machining load obtained in the monitoring section is out of the maximum or minimum permissive limit and then outputting normality or abnormality thereof.

2. The detecting method of claim 1, further comprising a stop operation setting step S450 of setting whether to stop the machine tool when the machining load exceeds the permissible limit between the permissible limit setting step S400 and the monitoring step S500.

3. The detecting method of claim 2, wherein, in the stop operation setting step S450, it is set that the machine tool is stopped immediately, before or after a machining operation.

4. The detecting method of claim 1, further comprising an alarm skip setting step S460 of allowing the operation of alarm to be skipped for preset times between the permissible limit setting step S400 and the monitoring step S500.

5. The detecting method of claim 1, wherein the monitoring step S500 comprises a monitoring data storing step S510 of storing monitoring data by tools, operations, dates and hours when operating the machine tool.

6. The detecting method of claim 2, further comprising an alarm skip setting step S460 of allowing the operation of alarm to be skipped for preset times between the permissible limit setting step S400 and the monitoring step S500.

7. The detecting method of claim 3, further comprising an alarm skip setting step S460 of allowing the operation of alarm to be skipped for preset times between the permissible limit setting step S400 and the monitoring step S500.

8. The detecting method of claim 2, wherein the monitoring step S500 comprises a monitoring data storing step S510 of storing monitoring data by tools, operations, dates and hours when operating the machine tool.

9. The detecting method of claim 3, wherein the monitoring step S500 comprises a monitoring data storing step S510 of storing monitoring data by tools, operations, dates and hours when operating the machine tool.
